(19) United States
(12) Patent Application Publication
(10) Pub. No.: US 2021/0190637 A1
(43) Pub. Date: Jun. 24, 2021

(54) ANALYSIS SYSTEM AND ANALYSIS METHOD

(71) Applicant: HORIBA, LTD., Kyoto (JP)

(72) Inventors: Takashi MATSUYAMA, Kyoto (JP); Ikue TAKAGI, Kyoto (JP)

(73) Assignee: HORIBA, LTD., Kyoto (JP)

(21) Appl. No.: 17/057,298

(22) PCT Filed: May 21, 2019
(86) PCT No.: PCT/JP2019/020067

§ 371 Date: Nov. 20, 2020

(30) Foreign Application Priority Data
May 22, 2018 (JP) 2018-098337

(51) Int. Cl. G01M 15/10; G01N 1/22

(52) U.S. Cl. CPC G01M 15/102; G01N 1/2252

(57) ABSTRACT

An analysis system configured to analyze exhaust gas exhausted front a lest article including an engine in order to facilitate determination of the source of particulate matter contained in the exhaust gas, includes a collection unit configured to collect the particulate matter contained in the exhaust gas, an elemental analysis unit configured to perform elemental analysis of the particulate matter collected in the collection unit, a storage unit configured to store content data of one or a plurality of elements contained in a constituent constituting a portion of the test article, and an inference unit configured to infer the source of the particulate matter on the basis of the content data stored in the storage unit and an elemental analysis result provided by the elemental analysis unit.

### TECHNICAL FIELD

The present invention relates to an analysis system configured to analyze exhaust gas or the like exhausted from an engine, and an exhaust-gas-unit analysis method.

### BACKGROUND ART

In recent years, there has been concern about the effects of particulate matter on the human body, and regulations on particulate matter emitted from automobiles have been tightened in countries and regions over the world.

As an apparatus used for measuring particulate matter, Patent Literature 1 discloses an apparatus in which exhaust gas is passed through a filter for collection, and the weights of the filter before and after the collection are compared, to thereby measure the weight of the particulate matter. Use of such an apparatus reveals, for example, variations in the amount of particulate matter emitted.

However, the particulate matter may be generated from various sources such as fuel, engine oil, and an exhaust-gas purification catalyst; even when variations in the amount of particulate matter emitted are revealed as described above, as long as the source of the particulate matter is not determined, a further reduction in the particulate matter is difficult to achieve. Such a problem in the analysis of exhaust gas exhausted from engines also applies to, for example, analysis of water discharged from fuel-cell vehicles.

### CITATION LIST

### Patent Literature

PTL 1: Japanese Unexamined Patent Application Publication No. 2010-13989

### SUMMARY OF INVENTION

### Technical Problem

Accordingly, the present invention has been made in order to address the above-described problem. A main object of the present invention is to facilitate determination of the source of particulate matter contained in exhaust gas.

### Solution to Problem

Specifically, an analysis system according to the present invention is an analysis system configured to analyze an exhausted substance exhausted from a test article that is a vehicle or a component thereof, the analysis system including an elemental analysis unit configured to perform elemental analysis of particulate matter contained in the exhausted substance; a storage unit configured to store content data of one or a plurality of elements contained in a constituent constituting a portion of the test article; and an inference unit configured to infer a source of the particulate matter on a basis of the content data stored in the storage unit and an elemental analysis result provided by the elemental analysis unit.

This analysis system having such a configuration includes the inference unit configured to infer the source of the particulate matter on the basis of the content data stored in the storage unit and the elemental analysis result provided by the elemental analysis unit; this facilitates user's determination of the source of the particulate matter based on the inferential result, which contributes to a further reduction in particulate matter.

A specific embodiment may further include a collection unit configured to collect particulate matter contained in exhaust gas exhausted from the test article, wherein the elemental analysis unit is configured to perform elemental analysis of the particulate matter collected in the collection unit.

Preferably, the storage unit is configured to store, as the content data, a content ratio of the one or plurality of elements contained in the constituent of the test article, and the inference unit is configured to infer the source of the particulate matter on a basis of the element content, ratio stored in the storage unit and an element content ratio included in the elemental analysis result.

Such a configuration infers the source of the particulate matter on the basis of the element content ratio stored in the storage unit and the element content ratio included in the elemental analysis result, to thereby provide a more reliable inferential result.

In this case, when measurement of particulate matter contained in exhaust gas having passed through the exhaust-gas purification catalyst reveals an increase in the amount of particulate matter emitted, in order to achieve a further reduction in the particulate matter, whether the cause of the increase exists in the engine or the exhaust-gas purification catalyst needs to be found.

Thus, preferably, the storage unit is configured to store, as the content data, one or a plurality of elements contained in an exhaust-gas purification catalyst serving as the constituent of the test article, and the inference unit is configured to infer that, on a basis of the content data and the elemental analysis result, the source of the particulate matter includes the exbaust-gas purification catalyst.

Such a configuration enables determination as to whether or not the source of the particulate matter includes the exhaust-gas purification catalyst, which facilitates finding as to whether the cause of the increase in particulate matter exists in the engine or the exhaust-gas purification catalyst.

When the cause of the increase in particulate matter is determined to exist in the exhaust-gas purification catalyst, for example, comparison between the measured numbers or masses of particulate matter in exhaust gas samples individually obtained from upstream and downstream regions of the exhaust-gas purification catalyst enables evaluation of the removal efficiency of the exhaust-gas purification catalyst.

However, even when this reveals a decrease in the removal efficiency of the exhaust-gas purification catalyst, deterioration of the exhaust-gas purification catalyst itself (for example, separation of the wish coating or the supported metal) cannot be detected.

Thus, preferably, the storage unit is configured to store content data for each of a wish coating, a supported metal, and a support that constitute the exhaust-gas purification catalyst, and the inference unit is configured to infer that, on a basis of the content data and the elemental analysis result, a deterioration constituent of the exhaust-gas purification catalyst is at least one of the wish coating, the supported metal, or the support.

Such a configuration enables determination of deterioration in the wish coating, the supported metal, or the support, which contributes to, for example, improvement in the exhaust-gas purification catalyst.

A specific embodiment for determining deterioration of the supported metal may be an embodiment in which the content data of the supported metal includes at least one of platinum (Pt), palladium (Pd), or rhodium (Rh), and the inference unit is configured to infer that the deterioration constituent of the exhaust-gas purification catalyst is the supported metal when a content of or an increase ratio of the content of at least one of platinum (Pt), palladium (Pd), or rhodium (Rh) included in the elemental analysis result is not less than a predetermined threshold.

A specific embodiment for determining deterioration of the wish coating or the support may be an embodiment in which the content data of the wish coating or the support includes at least one of aluminum (Al), zirconium (Zr), or titanium (Ti), and

the inference unit is configured to infer that the deterioration constituent of the exhaust-gas purification catalyst is the wish coating or the support when a content of or an increase ratio of the content of aluminum (Al), zirconium (Zr), or titanium (Ti) included in the elemental analysis result is not less than a predetermined threshold.

Preferably, a second collection unit configured to collect particulate matter contained in exhaust gas that is to pass through the exhaust-gas purification catalyst is further included, wherein the elemental analysis unit is configured to perform elemental analysis of the particulate matter collected in the second collection unit, and the inference unit is configured to compare an elemental analysis result of particulate matter collected in the collection unit and an elemental analysis result of the particulate matter collected in the second collection unit, to infer the deterioration constituent of the exhaust-gas purification catalyst.

When such a configuration reveals an element contained in a larger amount in the elemental analysis result of the particulate matter collected in the collection unit than in the elemental analysis result of the particulate matter collected in the second collection unit, the element is inferentially contained in the particulate matter derived from the exhaust-gas purification catalyst. Thus, on the basis of this element, the deterioration constituent of the exhaust-gas purification catalyst is interred.

On the other hand, when the cause of the increase in particulate matter is determined to exist in the engine, the cause is specifically, for example, fuel or engine oil.

Thus, preferably, the storage unit is configured to store, as the content data, one or a plurality of elements contained in engine oil serving as the constituent of the test article, and the inference unit is configured to infer that, on a basis of the content data and the elemental analysis result, the source of the particulate matter includes the engine oil.

Such a configuration enables, in the case where the cause of the increase in particulate matter exists in the engine, more specific inference of the source.

A more specific embodiment may be an embodiment in which the content data of the engine oil includes at least one of aluminum molybdenum (Mo), calcium (Ca), or zinc (In), and the inference unit is configured to infer that the source of the particulate matter includes the engine oil when a content of or an increase ratio of the content of molybdenum (Mo), calcium (Ca), or zinc (Zn) included in the elemental analysis result is not less than a predetermined threshold.

Preferably, the elemental analysis unit is configured to perform quantitative analysis of at least one of molybdenum (Mo), calcium (Ca), or zinc (Zn) contained in the particulate matter collected in the collection unit, and an oil consumption calculation unit is further included that is configured to calculate engine oil consumption by using at least a mass of at least one of molybdenum (Mo), calcium (Ca), or zinc (Zn) determined by the quantitative analysis, and a sampling flow rate of exhaust gas that is, of the exhaust gas exhausted from the test article, guided to the collection unit.

Such a configuration provides correlation between engine oil consumption and, for example, the amount of particulate matter emitted.

An analysis method according to the present invention is an analysis method for analyzing an exhausted substance exhausted from a test article that is a vehicle or a component thereof, the analysis method including an elemental analysis step of performing elemental analysis of particulate matter contained in the exhausted substance; a storing step of storing content data of one or a plurality of elements contained in a constituent constituting a portion of the test article; and an inference step unit of inferring a source of the particulate matter on a basis of the content data stored in the storing step and an elemental analysis result obtained in the elemental analysis step.

This analysis method provides the same advantages as in the above-described analysis system.

### Advantageous Effects of Invention

The present invention having such features facilitates determination of the source of particulate matter contained in an exhausted substance such as exhaust gas.

### BRIEF DESCRIPTION OF DRAWINGS

FIG. 1 is a schematic view illustrating the entire configuration of an analysis system according to a first embodiment.

FIG. 2 is a functional block diagram illustrating functions of a data processing device according to the embodiment.

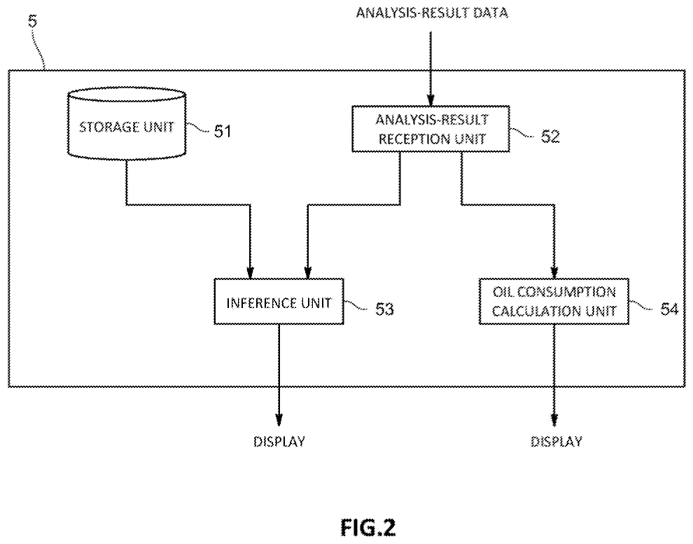

FIG. 3 is a flow chart illustrating operations of the analysis system according to the embodiment.

FIG. 4 is a schematic view illustrating the entire configuration of an analysis system according to a modification of the first embodiment.

FIG. 5 is a schematic view illustrating the entire configuration of an analysis system according to a second embodiment.

FIG. 6 is a schematic view illustrating the entire configuration of an analysis system according to a modification of the second embodiment.

### DESCRIPTION OF EMBODIMENTS

### First Embodiment

Hereinafter, an analysis system according to a first embodiment of the present invention will be described with reference to drawings.

An analysis system 100 according to this embodiment is used to evaluate, for example, performance of a test article including an engine E, and to analyze exhaust gas exhausted from the engine E. Incidentally, measurement of exhaust gas means that components contained in the exhaust gas are analyzed to measure the concentrations or masses of various components, or, for example, PM (mass) or PN (number) in the exhaust gas is measured. The engine is an internal combustion engine or external combustion engine used in, for example, a vehicle, a ship, or an aircraft. The test article including the engine E is a concept that encompasses even the engine E alone. The test article does not necessarily include the engine E as long as It includes a rotatable body, and may be, for example, a fuel-cell vehicle (hereafter, FCV), an electric vehicle (hereafter, EV), a component thereof, or a hybrid vehicle including both of an engine and a motor (hereafter, HV) . The subject to be analyzed by the analysis system 100 is not limited to exhaust gas as long as it is an exhausted substance exhausted from the test article, such as water discharged through a tail pipe.

Hereinafter, an embodiment of analyzing exhaust gas from a test vehicle V equipped with the engine E and driven on a chassis dynamometer will be described. Alternatively, the analysis system 100 may be configured to analyze exhaust gas from the engine E alone to which an engine dynamometer is connected, or may be configured to analyze exhaust gas from the engine E connected to a power train to which a dynamometer is connected.

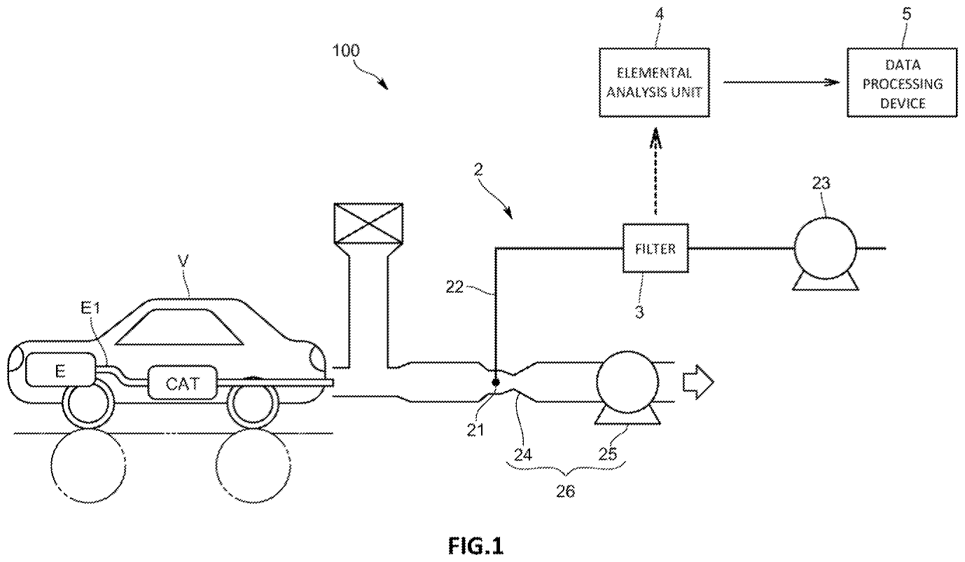

Specifically, as illustrated in FIG. 1, the analysis system 100 includes a sampling device 2 that samples a portion of or the entirety ox exhaust gas flowing through an exhaust pipe E1 connected to the engine E; a collection unit 3 that collects particulate matter contained in the sampled exhaust gas; an elemental analysis unit 4 that performs elemental analysis of the particulate matter collected in the collection unit 3; and a data processing device 5 that retrieves the analysis result of the elemental analysis unit 4 and infers the source of the particulate matter. Incidentally, this analysis system includes an exhaust-gas analysis device (not shown) that analyzes various components contained in the exhaust gas.

The sampling device 2 includes a sampling port 21 for sampling exhaust gas flowing through the exhaust pipe E1; an exhaust-gas line 22 connected to the sampling port 21; and a suction pump 23 disposed in the exhaust-gas line 22 and used for sectioning exhaust gas through the sampling port 21. In this embodiment, as illustrated in FIG. 1, the sampling device 2 is configured to dilute exhaust gas exhausted through the exhaust pipe E1 and diluted, with a dilution gas such as the air, by using a constant volume sampling device 26 (CVS) including a constant flow regulator 24 such as a critical flow Venturi and a suction pump 25.

The collection unit 3 is a filter that is disposed in the exhaust-gas line 22 and collects particulate matter in the exhaust gas. This filter 3 is disposed so as to be replaceable between the sampling port 21 and the suction pump 23 of the exhaust-gas line 22. From the mass of the post-collection filter 3, the mass of the pre-collection filter 3 is subtracted, to thereby determine the mass of PM particles collected in the filter 3. Incidentally, the filter 3 may be batch filters that are separated from each other, or a rolled filter used with a supply roll and a take-up roll. The material for the filter may be, for example, PTFE-coated glass fiber or PTFE.

The elemental analysis unit 4 is a fluorescence X-ray analyzer configured to irradiate a sample with X-rays and to detect generated fluorescent X-rays to thereby perform elemental analysis (qualitative analysis). This sample is particulate matter collected in the filter 3. This elemental analysis unit 4 can perform quantitative analysis of the mass or concentration (for example, mass concentration or element concentration) of elements contained in the particulate matter collected in the filter 3. When the filter 3 is batch filters, the filter 3 is removed from the sampling device 2, set to the elemental analysis unit 4, and subjected to elemental analysis. Alternatively, when the filter 3 is a rolled filter, the elemental analysis unit 4 is disposed near the filter 3 and performs elemental analysis without removing the filter 3 from the sampling device 2. In this case, the rolled filter 3 and the elemental analysis unit 4 may be integrated into a single device (filter-equipped elemental analyzer).

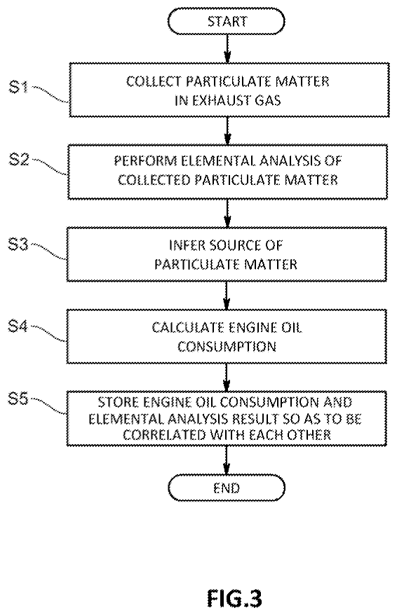

The data processing device 5 is a dedicated or general-purpose computer including, for example, a CPU, an internal memory, an input-output interface, and an AD converter. A program stored in the internal memory is used to provide, as illustrated in FIG. 3, functions of, for example, a storage unit 51, an analysis-result reception unit 52, and an inference unit 53.

The storage unit 51 stores content data of one or a plurality of elements contained in a constituent constituting a portion of the test article. This element data is digital data, and may include, in addition to the known concentration (such as mass concentration (%)) of one or a plurality of elements of the constituent, for example, the composition ratio or content ratio of the one or plurality of elements. The content data may be inputted by, for example, the user in advance, or may be transmitted from, for example, a server via Internet. Incidentally, such constituents are essential constituents of the test article during evaluation of, for example, performance of the test article, and are various constituents of a complete vehicle, such as engine oil and an exhaust-gas purification catalyst.

The storage unit 51 of this embodiment stores element data of elements contained in the engine oil, which is one of constituents of the teat article. Specifically, this element data includes at least one of molybdenum (Mo), calcium (Ca), or zinc (Zn), and may include, in a case of including a plurality of these, for example, the composition ratio or content ratio of these elements.

The analysis-result reception unit 52 receives the elemental analysis result obtained by the elemental analysis unit 4. This analysis result includes at least a qualitative analysis result provided by qualitative analysis of the particulate matter, and here also includes a quantitative analysis result provided by quantitative analysis of the particulate matter. The analysis-result reception unit 52 transmits the received analysis result data to the inference unit 53.

The inference unit 53 infers the source of the particulate matter analyzed by the elemental analysis unit, on the basis of the elemental analysis result received by the analysis-result reception unit 52 and the content data stored in the storage unit 51.

The inference unit 53 according to this embodiment is configured to infer engine oil as a source of the particulate matter when the engine oil is included as one of such sources. Specifically, when the content of or the increase ratio of the content of at least one of molybdenum (Mo), calcium (Ca), or zinc (Zn) included in the elemental analysis result is not less than a predetermined threshold, this inference unit 53 infers that the sources include the engine oil, and outputs the inference result on, for example, a display. Incidentally, the inference unit 53 may be configured to compare the content ratio of molybdenum (Mo), calcium (Ca), and zinc (Zn) included in the elemental analysis result with a preset reference ratio, and to infer that the sources include engine oil when the difference between the content ratio of at least one element and the reference ratio of the element is not less than a predetermined value. The inference unit 53 may be configured to infer that the sources include engine oil when the elemental analysis result includes one or more or ail of molybdenum (Mo), calcium (Ca), and zinc (Zn) irrespective of their content.

As described above, the analysis-result reception unit receives the quantitative analysis result of the particulate matter. The data processing device of this embodiment further has the function of an oil consumption calculation unit 54 of calculating engine oil consumption on the basis of the quantitative analysis result.

Specifically, the oil consumption calculation unit 54 uses the mass of at least one of (Mo), calcium (Ca), or sine (Zn) included in the quantitative analysis result, the flow rate of the sampling flow guided to the elemental analysis unit from the exhaust gas exhausted from the engine, and the flow rate of the raw exhaust gas exhausted from the engine (hereafter, also referred to as main flow rate) to calculate engine oil consumption, and outputs it on, for example, a display. Incidentally, as in this embodiment, when the raw exhaust gas is diluted with a dilution gas and the resultant diluted exhaust gas is guided to the collection unit, instead of the main flow rate, the dilution ratio and the flow rate of the diluted exhaust gas may be used to calculate engine oil consumption.

Hereinafter, an analysis method using the analysis system 100 according to this embodiment will be described with reference to a flow chart in FIG. 3.

First, the engine E is started, and particulate matter in exhaust, gas exhausted from the engine E is collected in the collection unit (S1).

Subsequently, the filter serving as the collection unit is conveyed to the elemental analysis unit, and the particulate matter collected in the collection unit is subjected to elemental analysis (S2). Specifically, elements contained in the particulate matter collected in the filter 3 are subjected to qualitative analysis, and here the elements contained in the particulate matter are also subjected to quantitative analysis. The analysis results are transmitted to the data processing device 5.

The data processing device 5 infers the source of the particulate matter collected in the collection unit on the basis of the content data stored in advance in the storage unit and the elemental analysis result obtained by the elemental analysis unit 4 (S3). Specifically, it infers that the source includes engine oil when the content of or the increase ratio of the content of at least one of molybdenum (Mo), calcium (Ca), or zinc (Zn) included in the elemental analysis result is not less than a predetermined threshold.

Subsequently, the data processing device 5 uses the elemental analysis result obtained by the elemental analysis unit 4, specifically the quantitative analysis result of the particulate matter to calculate engine oil consumption (S4). Incidentally, a specific example of the calculation method is described above. Incidentally, the engine oil consumption calculated in this way may be stored so as to be correlated with, for example, the elemental analysis result (qualitative analysis result or quantitative analysis result) of the elemental analysis unit (S5).

### Advantages of First Embodiment

The analysis system 100 has such a configuration including the inference unit 53 that infers the source of the particulate matter on the basis of the content data stored in the storage unit 51 and the elemental analysis result provided by the elemental analysis unit 4. This facilitates the user's determination of the source of the particulate matter on the basis of the inference result, which contributes to a further reduction in the particulate matter.

When the mass or number of particulate matter contained in the exhaust gas increases, it is necessary to determine whether the cause of the increase exists in the engine or in the exhaust-gas purification catalyst. The above-described analysis system 100 enables determination as to whether or not the source of the particulate matter includes engine oil, which facilitates finding of the cause of the increase in the particulates matter, and enables more specific inference of the source in the engine.

In addition, the oil consumption calculation unit 54 calculates engine oil consumption, and the engine oil consumption is stored so as to be correlated with the elemental analysis result. Thus, for example, driving conditions or causes of a high or low engine oil consumption can be analyzed from various viewpoints.

### Modification of First Embodiment

As described in the first embodiment, for example, the storage unit 51 may store, as the content data, the content ratio of one ox a plurality of elements. In this case, the inference unit 53 may be configured to compare the content ratio of the one or plurality of elements stored in the storage unit 51 with the content ratio of such elements included in the elemental analysis result, to infer the source of the particulate matter.

When the storage unit 51 stores, as the content data, the composition ratio of one or a plurality of elements, the inference unit 53 may be configured to compare the composition ratio of the one or plurality of elements stored in the storage unit 51 with the composition ratio of such elements included in the elemental analysis result, to infer the source of the particulate matter.

Such a configuration infers the source of the particulate matter on the basis of the content ratio or composition ratio of a plurality of elements, to thereby provide a more reliable inferential result.

In the above-described embodiment, the mass of at least one of (Mo), calcium (Ca), or zinc (Zn) included in the quantitative analysis result is used to calculate engine oil consumption. The oil consumption calculation unit 54 may have functions of a comparison unit of comparing the ratio (proportions) of a plurality of elements contained in the engine oil (for example, in the first embodiment, Mo, Ca, and Zn) with the ratio (proportions) of the elements included in the elemental analysis result, and a calculation unit of using the mass concentration of an element determined to be within a predetermined range by the comparison unit, to calculate engine oil consumption.

More specifically, the comparison unit performs the above-described comparison, to determine an element in which the difference between the ratios (proportions) is within a predetermined range. The predetermined range is a range for determining that such a ratio is the ratio of a plurality of elements of engine oil.

For example, consider a case where the ratio of a plurality of elements of engine oil is Mo: 5, Ca: 2, and Zn: 1. In this case, when the ratio of the elements included in the elemental analysis result is Mo: 5, Ca: 4, and Zn; 1, the comparison unit determines that Mo and Zn are elements within the predetermined range. Stated another way, the comparison unit determines that Ca is an element beyond the predetermined range. In this case, Ca contains Ca derived from the engine oil and Ca derived from another constituent. Incidentally, the thresholds for determining whether or not being within the predetermined range are, for example, values that are increased or decreased by a predetermined percent (for example, ±50%) from the proportions of elements in the content data.

The consumption calculation unit calculates engine oil consumption from the mass concentrations of elements determined by the comparison unit as being within the predetermined range (in the above-described example, Mo and Zn), and the measured masses of elements collected in the filter 3. Incidentally, the measured masses of elements are measured by the elemental analysis unit 4. In this case, the consumption calculation unit performs the above-described mathematical operation to calculate engine oil consumptions from the components, and the engine oil consumptions individually obtained for the plurality of elements are averaged and outputted. The calculated engine oil consumption is outputted on output means such as a display. In addition, from the mass of the particulate matter collected in the filter 3 and the mass concentrations of the elements, the masses of the elements collected in the filter 3 may be calculated. Incidentally, the mass of the particulate matter collected in the filter 3 can be determined by subtracting the mass of the pre-collection filter 3 from the mass of the post-collection filter 3.

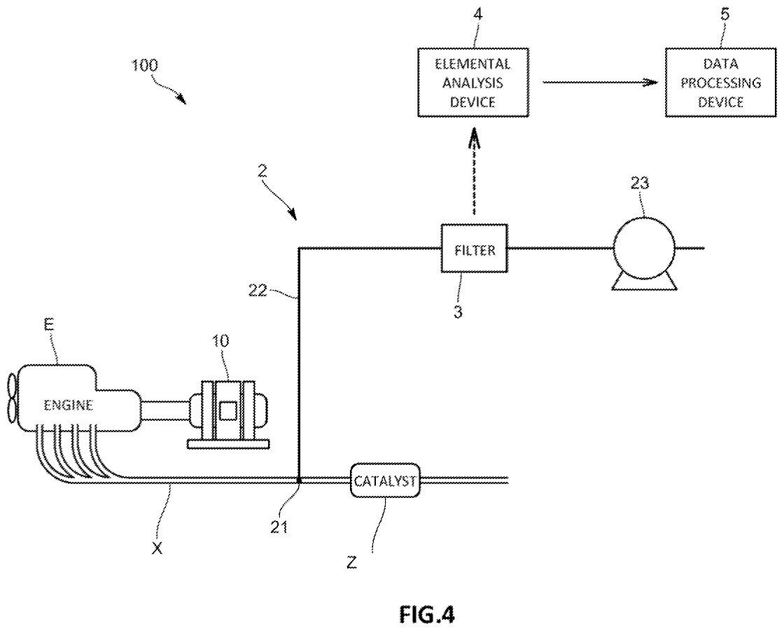

As illustrated in FIG. 4, the analysis system 100 may be configured to collect particulate matter contained in the exhaust gas to be passed through the catalyst 2, and to analyze the collected particulate matter using the elemental analysis unit 4.

Such a configuration enables elemental analysis of particulate matter contained in the exhaust gas exhausted from the engine E, without being affected by, for example, deterioration of the catalyst 2, which enables more accurate determination of the cause of particulate matter in the engine E.

### Second Embodiment

Hereinafter, an analysis system according to a second embodiment of the present invention will be described with reference to drawings.

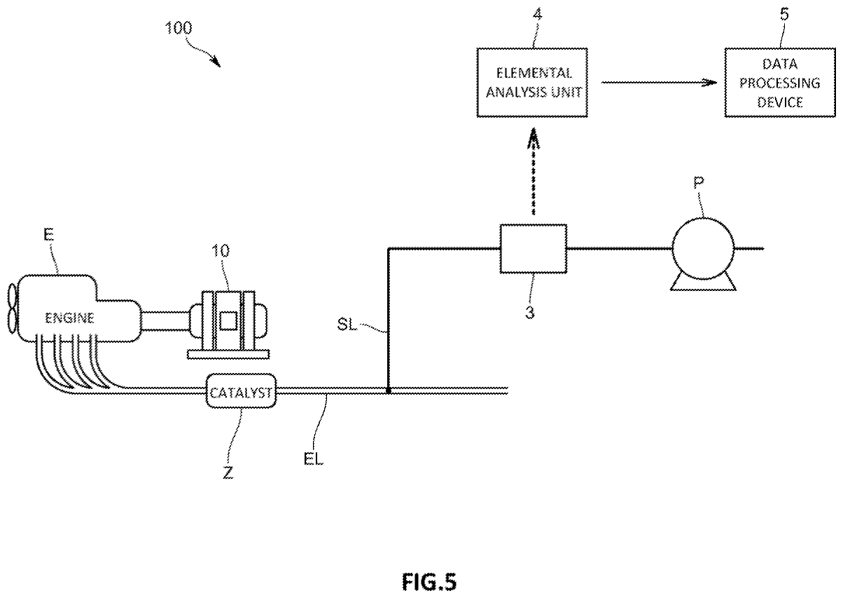

As illustrated in FIG. 5, the analysis system according to this embodiment is configured to collect particulate matter contained in exhaust gas exhausted from an engine E and passed through an exhaust-gas purification catalyst 2 (hereafter, simply referred to as catalyst 2), and perform elemental analysis of the collected particulate matter.

Incidentally, FIG. 5 illustrates an embodiment of analysis in which an engine dynamometer 10 is connected to the engine E itself; alternatively, this analysis system may be configured to perform analysis while a test vehicle equipped with the engine E is driven on a chassis dynamometer, or may be configured to perform analysis while a dynamometer is connected to a power train to which the engine E is connected.

Specifically, a catalyst evaluation system 100 includes an exhaust-gas line EL containing the catalyst Z; a sampling line SL that samples exhaust gas in a downstream region with respect to the catalyst 2 of the exhaust-gas line SL; a collection unit 3 that is disposed in the sampling line SL and collects particulate matter in the exhaust gas; an elemental analysis unit: 4 that performs elemental analysis of the collected particulate matter; and a data processing device 5 that retrieves the elemental analysis result from the elemental analysis unit 4. The catalyst Z is, for example, a three-way catalyst for GPF (Gasoline Particulate Filter) or DPF (Diesel Particulate Filter).

In this embodiment, of the functions of the data processing device 5, the storage unit 51 and the inference unit 53 are different from those in the first embodiment and will be described in detail as follows.

The storage unit 51 of this embodiment stores element data of elements of the catalyst serving as one of the constituents of the teat article. Specifically, the element data includes at least one of platinum (Pt), palladium (Pd), rhodium (Rh), aluminum (Al), zirconium (Zr), or titanium (Ti); when it includes a plurality of these, it may include, for example, the composition ratio or content ratio of these elements.

The storage unit 51 stores, as the content data, one or a plurality of elements contained in each of a wish coating, a supported metal, and a support that constitute the catalyst Z. Specifically, the content data of the supported metal includes at least one of platinum (Pt), palladium (Pd), or rhodium (Rh); and the content data of the wish coating or the support includes at least one of aluminum (Al), zirconium (Zr), or titanium (Ti). Incidentally, the content data may ho tabular data in which a constituent constituting the catalyst Z is linked to one or a plurality of elements contained in the constituent.

The inference unit 53 of this embodiment is configured to infer that the catalyst Z is a source of the particulate matter when the catalyst Z is included as one of such sources. Specifically, the inference unit 53 infers that the sources include the catalyst Z and outputs the inference result on, for example, a display when the content of or the increase ratio of the content of at least one of platinum (Pt), palladium (Pd), rhodium (Rh), aluminum (Al), zirconium (Zr), or titanium (Ti) included in the elemental analysis result is not less than a predetermined threshold. Incidentally, as in the first embodiment, instead of the content or the increase ratio of the content, the content ratio or the composition ratio may be used.

In addition, the inference unit 53 is configured to compare the elemental analysis result received by the analysis-result reception unit 52 with the content data stored in the storage unit 51, to infer the deterioration constituent of the catalyst Z.

The inference unit 53 of this embodiment is configured to infer the deterioration constituent of the catalyst Z from at least the wish coating, the supported metal, and the support; specifically, it infers that the deterioration constituent is the supported metal when the content of or the increase ratio of the content of platinum (Pt), palladium (Pd), or rhodium (Rh) included in the elemental analysis result is not less than a predetermined threshold, or infers that the deterioration constituent of the catalyst 1 is the wish coating or the support when the content of or the increase ratio of the content of aluminum (Al), zirconium (Zr), or titanium (Ti) included in the elemental analysis result is not less than a predetermined threshold. Incidentally, whether the deterioration constituent is the wish coating or the support may be interred on the basis of, for example, the composition ratio of aluminum (Al), zirconium (Zr), and titanium (Ti) included in the elemental analysis result.

### Advantages of Second Embodiment

The analysis system 100 having such a configuration enables determination as to whether or not the source of the particulate matter Includes the catalyst Z, which facilitates finding as to whether the cause of the increase in the particulate matter exists in the engine E or in the catalyst Z.

In addition, it enables determination of the deterioration constituent of the catalyst 2, so that, for example, an appropriate action can be taken in order to increase the purification performance (removal efficiency) of the catalyst Z.

### Modification of Second Embodiment

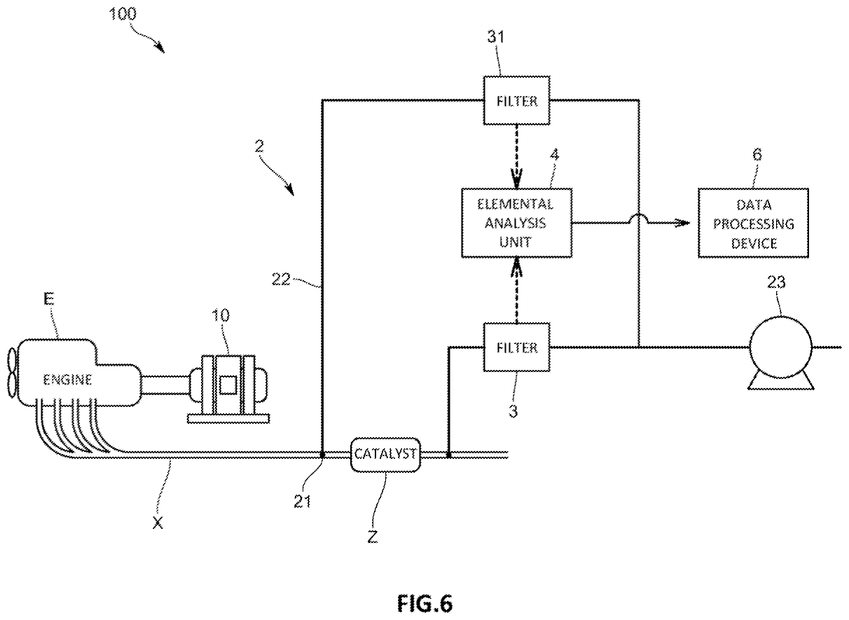

For example, as illustrated in FIG. 6, the analysis system 100 may include a second collection unit that collects particulate matter contained in exhaust gas sampled in an upstream region with respect to the catalyst Z, and may be configured to sample exhaust gases in upstream and downstream regions with respect to the catalyst Z, and to subject particulate matter contained in the exhaust gases to elemental analysis.

With such a configuration, for example, when an element is found to be contained more in the particulate matter contained in the exhaust gas sampled in the downstream region with respect to the catalyst Z than in the particulate matter contained in the exhaust gas sampled in the upstream region with respect to the catalyst Z, the element, is inferentially derived from the deterioration constituent of the catalyst Z. This enables more accurate determination of the deterioration constituent of the catalyst Z.

### Other Embodiments

In the above-described embodiments, the data processing device 5 is configured to infer the source of the particulate matter. Alternatively, the analysis result of the elemental analysis unit 4 may be displayed on, for example, a display so as to enable comparison, and the user may infer the source of the particulate matter.

The elemental analysis unit 4 in the first embodiment is configured to irradiate the sample with primary X-rays and detect the resultant fluorescent X-rays to achieve elemental analysis; alternatively, it may be configured to detect scattered X-rays or photoelectrons due to irradiation with primary X-rays to achieve elemental analysis.

The test article for the analysis system 100 may be, for example, a FCV, an EV, a HV, or a two-wheeled vehicle, or a constituent of these may be employed as the test article.

Incidentally, the FCV causes a reaction between hydrogen and air (such as compressed air) to generate electricity during which water is generated. Thus, when the FCV is employed as the test article, the elemental analysis unit 4 in the embodiments may analyze water discharged through the tail pipe of the FCV. In this case, the storage unit 51 may store one or a plurality of elements contained in the fuel cell serving as one of the constituents of the test article, or the content ratio of such elements. Examples of the elements contained in the fuel cell include aluminum (Al), titanium (Ti), and iron (Fe) contained in the separator or electrodes, and phosphorus (P) and carbon (C) contained in the electrolyte or active materials. The elemental analysis unit 4 can determine that, on the basis of the analysis result of the water and the one or plurality of elements contained in the fuel cell or the content ratio of such elements stored in the storage unit 51, the source of the particulate matter is derived from the fuel cell.

The present invention is not limited to the above-described embodiments, and various modifications can be obviously made without departing from the spirit and scope of the present invention.

### REFERENCE SIGNS LIST

100 analysis system

E engine

2 exhaust-gas sampling device

3 collection unit

4 elemental analysis unit

5 data processing device

51 storage unit

52 analysis-result. reception unit

53 inference unit

### INDUSTRIAL APPLICABILITY

The present invention facilitates determination of the source of particulate matter contained in, for example, exhaust gas.

1. An analysis system configured to analyze an exhausted substance exhausted from a test article that is a vehicle or a component thereof, the analysis system comprising:
an elemental analysis unit configured to perform elemental analysis of particulate matter contained in the exhausted substance;
a storage unit configured to store content data of one or a plurality of elements contained in a constituent constituting a portion of the test article; and
an inference unit configured to infer a source of the particulate matter on a basis of the content data stored in the storage unit and an elemental analysis result provided by the elemental analysis unit.

2. The analysis system according to claim 1, further comprising: a collection unit configured to collect particulate matter contained in exhaust gas exhausted from the test article,
wherein the elemental analysis unit is configured to perform elemental analysis of the particulate matter collected in the collection unit.

3. The analysis system according to claim 1, wherein the storage unit is configured to store, as the content data, a content ratio of the one or plurality of elements contained in the constituent of the test article, and
the inference unit is configured to infer the source of the particulate matter on a basis of the element content ratio stored in the storage unit and an element content ratio included in the elemental analysis result.

4. The analysis system according to claim 1, wherein the storage unit is configured to store, as the content data, one or a plurality of elements contained in an exhaust-gas purification catalyst serving as the constituent of the test article, and
the inference unit is configured to infer that, on a basis of the content data and the elemental analysis result, the source of the particulate matter includes the exhaust-gas purification catalyst.

5. The analysis system according to claim 4, wherein the storage unit is configured to store content data for each of a wish coating, a supported metal, and a support that constitute the exhaust-gas purification catalyst, and
the inference unit is configured to infer that, on a basis of the content data and the elemental analysis result, a deterioration constituent of the exhaust-gas purification catalyst is at least one of the wish coating, the supported metal, or the support.

6. The analysis system according to claim 3, wherein the content data of the supported metal includes at least one of platinum (Pt), palladium (Pd), or rhodium (Rh), and
the inference unit is configured to infer that the deterioration constituent of the exhaust-gas purification catalyst is the supported metal when a content of or an increase ratio of the content of at least one of platinum (Pt), palladium (Pd), or rhodium (Rh) included in the elemental analysis result is not less than a predetermined threshold.

7. The analysis system according to claim 3, wherein the content data of the wish coating or the support includes at least one of aluminum (Al), zirconium (Zr), or titanium (Ti), and
the inference unit is configured to infer that the deterioration constituent of the exhaust-gas purification catalyst is the wish coating or the support when a content of or an increase ratio of the content of aluminum (Al), zirconium (Zr), or titanium (Ti) included in the elemental analysis result is not less than a predetermined threshold.

8. The analysis system according to claim 3, further comprising a second collection unit configured to collect particulate matter contained in exhaust gas that is to pass through the exhaust-ga3 purification catalyst,
wherein the elemental analysis unit is configured to perform elemental analysis of the particulate matter collected in the second collection unit, and
the inference unit is configured to compare an elemental analysis result of particulate matter collected in the collection unit and an elemental analysis result of the particulate matter collected in the second collection unit, to infer the deterioration constituent of the exhaust-gas purification catalyst.

9. The analysis system according to claim 1, wherein the storage unit is configured to store, as the content data, one or a plurality of elements contained in engine oil serving as the constituent of the test article, and
the inference unit is configured t:o infer that, on a basis of the content, data and the elemental analysis result, the source of the particulate matter includes the engine oil.

10. The analysis system according to claim 9, wherein the content data of the engine oil includes at least one of aluminum molybdenum (Mo), calcium (Ca), or zinc (Zn), and
the inference unit is configured to infer that the source of the particulate matter includes the engine oil when a content of or an increase ratio of the content of molybdenum (Mo), calcium (Ca), or zinc (Zn) included in the elemental analysis result is not less than a predetermined threshold.

11. The analysis system according to claim 8, wherein the elemental analysis unit is configured to perform quantitative analysis of at, least one of molybdenum (Mo), calcium (Ca), or zinc (Zn) contained in the particulate matter collected in the collection unit, and
the analysis system further comprises an oil consumption calculation unit configured to calculate engine oil consumption by using at least a mass of at least one of molybdenum (Mo), calcium (Ca), or zinc (Zn) determined by the quantitative analysis, and a sampling flow rate of exhaust gas that is, of the exhaust gas exhausted from the test article, guided to the collection unit.

12. An analysis method for analyzing an exhausted substance exhausted from a test article that is a vehicle or a component thereof, the analysis method comprising:
an elemental analysis step of performing elemental analysis of particulate matter contained in the exhausted substance;
a storing step of storing content data of one or a plurality of elements contained in a constituent constituting a portion of the test article; and
an inference step unit of inferring a source of the particulate matter on a basis of the content data stored in the storing step and an elemental analysis result obtained in the elemental analysis step.
